(19) United States
(12) Patent Application Publication
(10) Pub. No.: US 2010/0036817 A1
(43) Pub. Date: Feb. 11, 2010

(54) SYSTEM FOR CONTROLING DOCUMENTS IN A COMPUTER

(76) Inventors: Hwan Kuk Bae, Seoul (KR); Yang Jin Seo, Seoul (KR); Sang Hak Nah, Seoul (KR)

Correspondence Address: IPLA P.A., 3550 WILSHIRE BLVD., 17TH FLOOR, LOS ANGELES, CA, 90010, US

(21) Appl. No.: 12/518,868

(22) PCT Filed: Dec. 11, 2007
(86) PCT No.: PCT/KR07/06448

§ 371 Date: Jun. 11, 2009

(30) Foreign Application Priority Data
Dec. 11, 2006 (KR) 10-2006-0125831

(51) Int. Cl. G06F 17/30

(52) U.S. Cl. 707/3; 707/10; 707/E17.01; 707/E17.008; 707/E17.014

(57) ABSTRACT

Disclosed herein is a control system. The control server includes a management server, a plurality of client terminals configured to includes first and second client terminals and communicate with the management server, and a file server configured to store documents shared by the first and second client terminals. Each of the first and second client terminals includes an external device recognition module that reads codes of external devices that are communicably connected to or separated from the first or second client terminal. The management server includes an external device DB that stores the codes of the external devices, and an external device verification module that searches the external device DB for information about a code, and performs control so that a document stored in the file server is stored in an external device and is then transferred from the file server if the information about the code is found to exist.

### TECHNICAL FIELD

The present invention relates to a system for controlling the entry and exit of confidential documents that, in a file server that enables a plurality of terminals or users to share various documents, such as drawing files, image files, text files, moving image files and Musical Instrument Digital Interface (MIDI) files, performs control when the terminals or users access the file server, view documents and transfer documents from the file system using external devices when necessary.

### BACKGROUND ART

Since various types of information documents (hereinafter referred to as “documents”), such as drawing files, image files, text files, moving image files, and MIDI files, which are utilized in enterprises and government offices, must be able to be accessed and utilized by a plurality of users having relationships with the enterprises and government offices, the documents are stored in a file server and are then shared in an environment in which a plurality of client terminals is connected via the Web or a network.

FIG. 1 is a view showing communication between a management server, a file server and terminals in a Web or network environment. The following description will be given with reference to this drawing.

A system that is configured such that a plurality of users shares information while communicating with each other mainly includes a plurality of client terminals 30, 30′, and 30″ which communicate with each other via the Web or a network, and a management server 10 which is connected to the client terminals 30, 30′, and 30″ while managing the communication therebetween.

The management server 10 can control the communication between the client terminals 30, 30′, and 30″ and supervise communication with the outside for the purpose of security, and can store necessary documents and then provide documents in response to the request of the client terminals 30, 30′, and 30.″ Since the construction of the management server 10 is part of a widely-known conventional system, an additional description thereof will be omitted here.

Meanwhile, as the amount of information increases and the management thereof is considered more important, the specialized management of information has been required. Therefore, for conventional functions of the management server 10, a file sharing server 20 (hereinafter referred to as a file server) manages the operation of storing and managing information, and the management server 10 performs only the operations of performing communication control and security between the client terminals 30, 30′, and 30″.

However, the file server 20 may contain important confidential information, which must not be open to the public, in the documents thereof, in addition to information which can be open to the public. Therefore, in order to prevent the illegal leakage of confidential information, access to the file server, which contain confidential information in the documents thereof, can be made only through authorized client terminals 30, 30′, and 30″, so that the documents can be viewed only in the corresponding client terminals 30, 30′, and 30″.

Here, the term “view” collectively refers to ‘retrieving a document’, ‘viewing a document’, ‘editing a document’, and ‘transferring a document’.

However, in the conventional security method, access to the file server 20 can be made through the authorized client terminals 30, 30′, and 30″, and there is no difficulty of leaking stored documents after the access has been made. Furthermore, since no accurate data or evidence for the leaked documents remains, a problem occurs in that it is difficult to chase the user responsible for leaking the documents and the reliability of the results of the chase is low. In consequence, the conventional security method for a file server has a structure in which security for corresponding documents is determined depending on the awareness and determination of users who are authorized to access the file server 20.

That is, since the security of a network, including the management server 10, the file server 20, and the client terminals 30, 30′ and 30″, is determined depending on the intention of users, the reliability of security must be low.

### DISCLOSURE

### Technical Problem

Accordingly, the present invention has been made keeping in mind the above problems occurring in the prior art, and an object of the present invention is to provide a system for controlling the entry and exit of confidential documents that is capable of controlling the exit of confidential documents, thereby preventing the leakage of documents without authorization.

Another object of the present invention is to provide a system for controlling the entry and exit of confidential documents that can makes access to or the use of documents, stored in a file server shared by a plurality of client terminals, easy and provides more effective security, thereby enabling the more secure and effective use of the shared documents.

### Technical Solution

In order to accomplish the above objects, the present invention provides a control system including a management server, a plurality of client terminals configured to comprise first and second client terminals and communicate with the management server, and a file server configured to store documents shared by the first and second client terminals, wherein:

each of the first and second client terminals includes an external device recognition module that reads the codes of external devices that are communicably connected to or separated from the first or second client terminal; and

the management server includes an external device DB that stores the codes of the external devices, and an external device verification module that, when the code of an external device, connected to the first or second client terminal, is received from the external device recognition module, searches the external device DB for information about the code, and performs control so that a document stored in the file server is stored in the external device connected to the first or second client terminal and is then transferred from the file server if the information about the code is found to exist as a result of the search.

### ADVANTAGEOUS EFFECTS

According to the above-described present invention, the exit of confidential documents through external devices is completely controlled in a system in which a management server and client terminals communicate with each other, a file server, storing various documents, communicates with the management server and the client terminals and the documents stored in the file server are shared, so that there is an effect in that the problems with the prior art security system, which depends solely on users' selection and conscience, can be overcome.

Furthermore, each user's rights or authorization limits to view documents can be changed rapidly upon a superior's approval, and the user can effectively view non-open documents required for work through the above-described change, so that there is an effect in that flexible viewing, as well as complete document security, can be realized in a limited document environment.

Additionally, at the time of accessing a file server through a plurality of client terminals, the authorization limits of access to shared documents are discriminated for respective users, so that there is an effect in that document security can be managed in detail.

Furthermore, since a necessary document can be opened or searched for using a dedicated security explorer tool at the time of accessing a file server, the user can have the sensation of working in a local area, so that there is an effect in that the user can perform more stable and efficient document work.

Furthermore, since information files are provided in respective documents, requiring security, or documents are collected in a document DB, and then access to the documents is controlled and managed for respective users, there is the weak possibility of collision or corruption of a relevant document when two or more users simultaneously perform work on the same document, so that more secure document work can be conducted.

### DESCRIPTION OF DRAWINGS

FIG. 1 is a diagram showing communication between a management server, a file server and terminals;

FIG. 2 is a block diagram showing the construction of FIG. 1 in detail based on a control system according to the present invention;

FIG. 3 is a flowchart of a control method showing a process of accessing documents and then viewing the documents using the control system of the present invention of FIG. 2 in steps;

FIG. 4 is an image showing the posting of the menu option of a file server security explorer tool according to the present invention on the GUI of Windows™; and

FIG. 5 is a GUI image showing the running of a file server security explorer tool according to the present invention; and

FIG. 6 is a block diagram showing another embodiment of the control system according to the present invention.

### MODE FOR INVENTION

The present invention will be described in detail below with reference to the accompanying drawings.

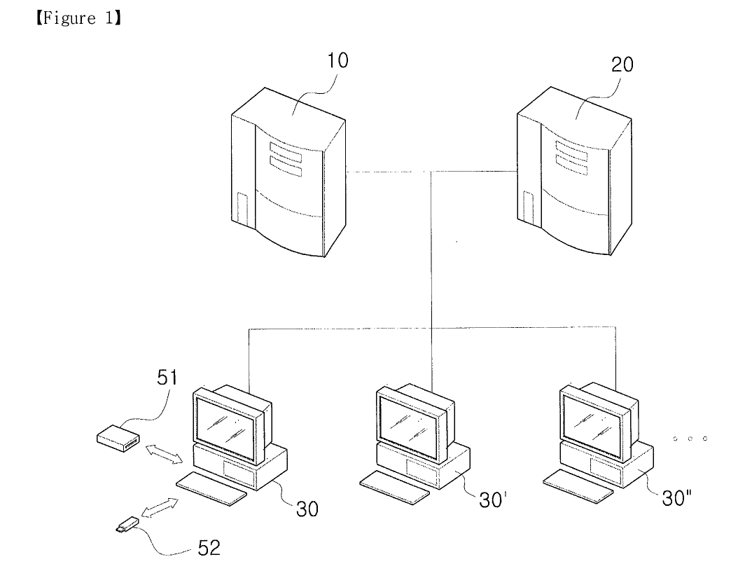

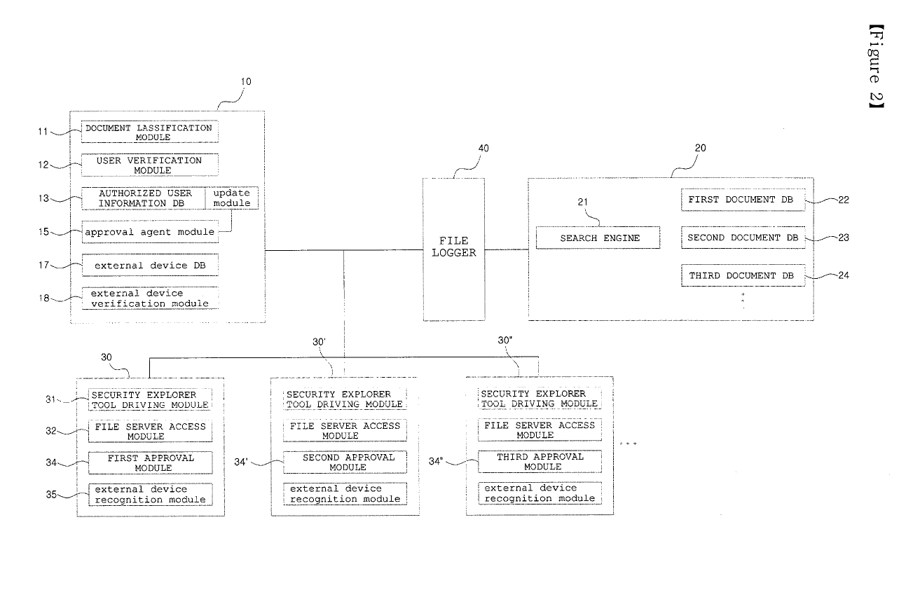

FIG. 2 is a block diagram showing the construction of FIG. 1 in detail based on a control system according to the present invention. The following description will be given with reference to this drawing.

The control system according to the present invention is intended to protect documents stored in a file server 20. The control system controls not only the viewing of the documents through client terminals 30, 30′ and 30″ but also the exit of the documents through external devices 51 and 52, such as a Digital Versatile Disk (DVD)/Rewritable (RW), Universal Serial Bus (USB) memory, a Personal Digital Assistant (PDA), an Moving Picture Exports Group Audio Layer-3 (MP3) player, a digital camera and a mobile phone.

That is, in the case where a user views a document stored in a file server 20 using his or her own client terminal 30, 30′ or 30″ and wants to transfer the document to the outside as needed, the user's rights to transfer the document to the outside is verified, the rights are acquired through a superior's approval if there is no rights to transfer the document to the outside, and then the relevant document is transferred to the outside.

The control system of the present invention for performing the above-described functions is installed in/applied to a structure in which a management server 10, a file server 20 and a plurality of client terminals 30, 30′ and 30″, which are connected to the management server 10 and the file server 20 and communicate with each other via the Web or a network environment, are included, and functions to control the access of the client terminals 30, 30′, 30″ to the file server 20, manage the viewing of documents stored in the file server 20, and supervise and manage the exit of the documents.

Furthermore, the control system rapidly changes the user's rights of access through the client terminal 30, 30′ or 30″, so that the user can flexibly perform the viewing of confidential documents.

For this purpose, the management server 10 includes a user verification module 12 for identifying the users of the client terminals 30, 30′ and 30″, an authorized user information DB 13 for storing information about the users, and a document classification module 11 for searching for and classifying documents that are discriminately open to respective users.

Meanwhile, the file server 20 includes a document DB for storing documents and a search engine 21 for managing/searching the document DB. Here, the document DB may include two or more document DBs when necessary.

For reference, the document DB includes a plurality of DB drives from the point of view of hardware and is then divided into a first document DB 22, a second document DB 23, a third document DB 24 and so on. In a single drive device, the area of a disk is divided and is then classified into a first document DB 22, a second document DB 23, a third document DB 24 and so on. The concept of a virtual disk may be applied to the latter case, which will be described in detail below.

Meanwhile, the client terminals 30, 30′ and 30″ are two or more in number. Each of the client terminals 30, 30′ and 30″ includes a security explorer tool driving module 31, which performs control on the running of the security explorer tool, which is a management method of the control system according to the present invention, and a file server access module 32, which is a device for performing a procedure for determining whether access to the file server 20 has been authorized.

A plurality of documents, stored in the file server 20, may include general open documents requiring no security and confidential documents requiring security. The opening of the confidential document may be restricted depending on the user. That is, although a plurality of users can access the file server 20 through a plurality of client terminals 30, 30′ and 30″, some users' viewing of specific documents is entirely or partially restricted.

Meanwhile, the restriction on users' viewing of documents is related to the exit of the document. That is, the control system according to the present invention controls and interferes with the transfer of documents from the file server 20 even by users having rights to view or edit the relevant documents, thereby realizing active control and security without entrusting document security to the users' conscience.

For this purpose, each of the client terminals 30, 30′ and 30″ according to the present invention includes an external device recognition module 35, and the management server 10 includes an external device DB 17 and an external device verification module 18.

As described above, each of the external device 51, 52 accesses/communicates with a corresponding client terminal 30, 30′ or 30″ via a connector, which is connected to the serial/parallel port or USB port of the client terminal 30, 30′ or 30″, and can receive and store a document stored in the client terminal 30, 30′ or 30″ or documents existing in the file server 20 under the control of the user. The control system according to the present invention supervises the exit of documents to the external devices 51 and 52, and controls the exit of a document when the exit of the document that is not authorized or exceeds the rights is performed, thereby preventing the unrestricted exit and opening of documents.

A control method related to the exit of documents and a construction for performing the control method will be described in greater detail below.

Meanwhile, a user who is not authorized to view confidential documents may need to view the confidential documents due to the progress of work or environmental circumstances, or for various reasons.

For this purpose, the control system according to the present invention can rapidly and flexibly adjust the authorization limits of the user for the documents stored in the file server 20.

In order to help understand the technical spirit of the control system according to the present invention, a process in which a user accesses the file server 20 using one of the client terminals 30, 30′ or 30″ and views documents stored in the file server 20 will be described below.

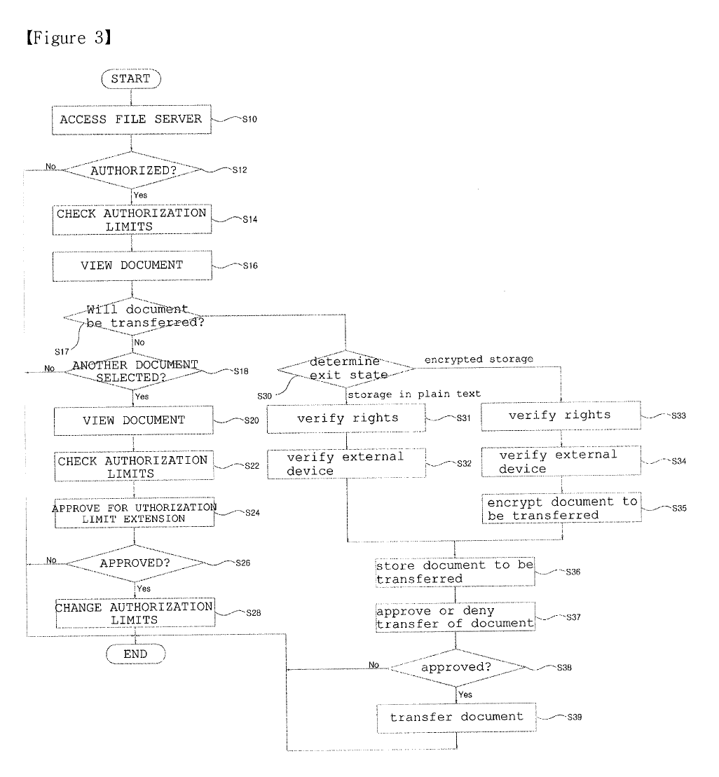

FIG. 3 is a flowchart of a control method showing the process of accessing the documents using the control system of the present invention of FIG. 2 and viewing the documents in steps. The following description will be given with reference to this drawing.

S10; File Server Access Step

A user accesses the file server 20 via one of the client terminals 30, 30′ and 30″. Here, the client terminals 30, 30′ and 30″ may communicate with the file server 20 via the Web or a restricted network such as a mobile local area network.

Although, in the embodiment: of the present invention, communication between the client terminals 30, 30′ and 30″, the management server 10 and the file server 20 is performed using the latter communication network, which is not accessible to external persons, the technical spirit of the present invention is not limited thereto.

The method by which a user accesses the file server 20 via one of the client terminals 30, 30′ and 30″ is various. However, the control system according to the present invention adopts the configuration of Windows™ Explorer in order to access the file server 20.

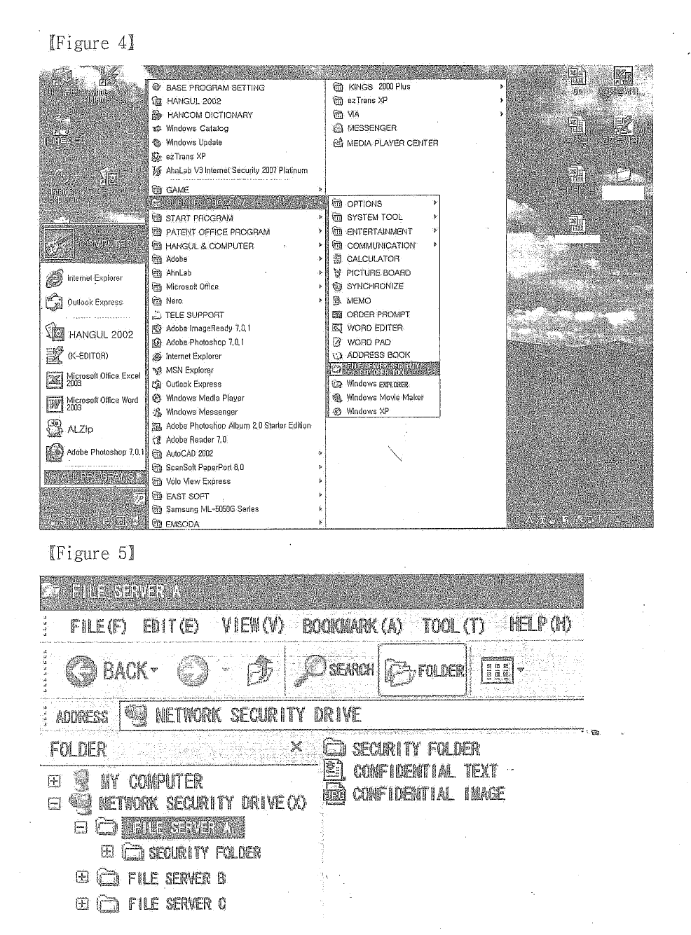

That is, as shown in FIG. 4 (an image that shows a menu option for a file server security explorer tool according to the present invention, which is posted on the GUI of Windows™), the “file server security explorer tool” of the control system according to the present invention is posted near “Windows Explorer”, so that the users of the client terminals 30, 30′ and 30″ can perform work with a sensation like the sensation of searching for and opening documents in local PC client terminals.

Furthermore, the security explorer tool according to the present invention may be implemented using a dll module, such as ‘Shell name extension’ or ‘ActiveX’, besides the method like that of “Windows Explorer.”

Meanwhile, access to the file server 20 is not uniformly authorized without discrimination between the client terminals 30, 30′ and 30″. That is, one client terminal 30 may access the file server 20, and the other client terminals 30′ and 30″ may not access the file server 20. This can be made possible by installing a file server access module 32, including an authorization file, in the client terminal 30 that has been authorized to access the file server 20.

The menu option of the “file server security explorer tool” can be seen in the client terminal 30 in which the file server access module 32 is installed, as shown in FIG. 4, while the menu option cannot be seen in the client terminals 30′ and 30″ in which the file server access module 32 is not installed.

However, since this is merely one of various embodiments related to whether the menu option of the “file server security explorer tool” can be seen, the technical spirit of the present invention is not limited thereto (the “file server security explorer tool” may not be executed in the client terminal 30 that cannot access the file server even when the “file server security explorer tool” is seen).

S12; Authorization Verification Step

When a user selects the menu option of the “file server security explorer tool,” the file server access module 32 checks whether a currently running client terminal 30, 30′ or 30″ has been authorized while communicating with the management server 10.

Thereafter, if the client terminal 30 is determined to be an authorized terminal, the file server access module 32 outputs an ID/password input window to the client terminal 30 so as to verify whether the user has been authorized.

However, the present invention is not limited thereto. That is, (1) whether to activate the security explorer tool may be determined by directly outputting an ID/password input window for verifying whether a user has been authorized and verifying whether the user has been authorized using an ID/password input through the input window without verifying whether the client terminal 30, 30′ or 30″ has been authorized, and (2) whether to activate the security explorer tool may be processed by executing the security explorer tool in an authorized client terminal 30, 30′ or 30″ without verifying the authorization of a user in such a way that the file server verifies whether the accessing client terminal 30, 30′ or 30″ has been authorized.

In the latter case, when an unauthorized client terminal 30, 30′ or 30″ attempts to execute the security explorer tool, a window showing a sentence, such as “access is denied,” is output, thereby informing the user of the impossibility of access to the security explorer tool.

Although the authentication process may be implemented in various embodiments, the technical spirit of the present process will be described through an embodiment using an ID and a password. Of course, the technical spirit of the present invention may be modified and practiced in various manners within a range that does not depart from the attached claims.

When the user inputs his or her ID and password to the input window, the file server access module 32 sends the authentication information (ID/password) to the user verification module 12 of the management server 10.

The user verification module 12 searches authorized user information DB 13 for information identical to the authentication information.

The authorized user information DB 13 may contain various types of personal information, including users' authentication information, and the user verification module 12 checks whether the user who attempts to access the file server 20 is a user who has been authorized to access the file server 20 using the authentication information.

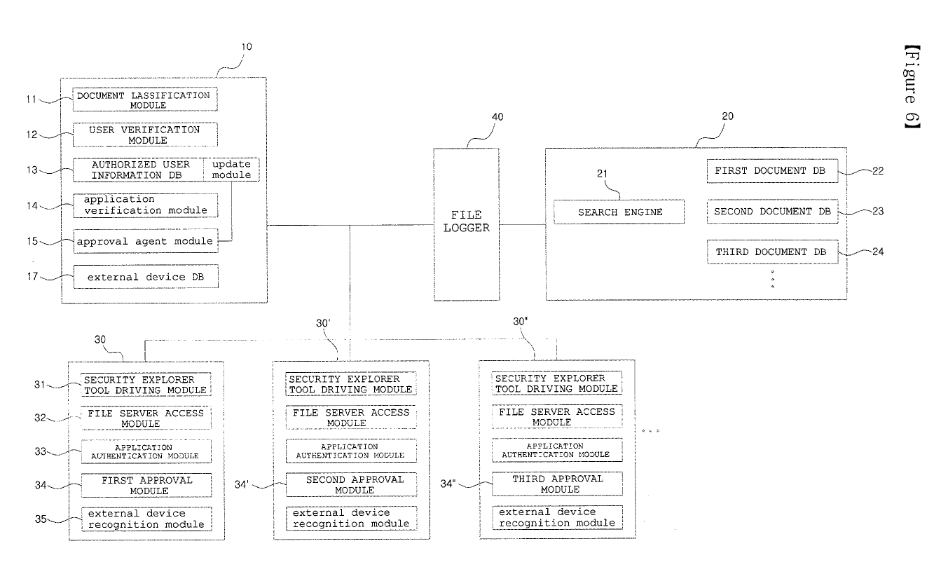

If, as a result of the authentication by the user verification module 12, the user is determined to be an unauthorized user, the user's access to the file server 20 is denied. In contrast, if the user is an authorized user, the user verification module 12 sends a driving signal to the security explorer tool driving module 31. As a result, the security explorer tool driving module 31 activates the file server security explorer tool according to the present invention, and thus the user can access/search the file server using a method similar to a method of using the well-known Windows Explorer, as shown in FIG. 5 (an image showing a GUI that shows the operation of the file server security explorer tool according to the present invention).

In the shown embodiment, a ‘network security drive’, which is a directory for the file server 20, is found through the security explorer tool, and a plurality of file servers A to C is included in the ‘network security drive’. The file servers A to C refer to the first, second and third document DBs 22, 23 and 24, respectively. Depending upon the authentication of a user, information about all or part of the file servers A to C may be output. Through this, the user can access a relevant first, second or third document DB 22, 23 or 24 by clicking on information about only a relevant file server.

Of course, since a user who has not been authorized for access to the file server 20 cannot find the ‘network security drive’ itself through the security explorer tool, it is impossible for the user to access the file server 20.

S14; Authorization Limits Checking Step

As described above, the control system according to the present invention may discriminate between accessible documents even for respective users who have been authorized for access to the file server 20.

Of course, it is possible to show all the documents of a relevant file server 20 to a user who has succeeded in accessing the file server 20, and to determine whether the user has been authorized to view a relevant document and to then open the document or deny the viewing of the document when the user selects one from among the documents and attempts to view the document. However, in the embodiment of the present invention, documents output to the file server security explorer tool are initially discriminated between for respective users and then output.

That is, a user can view all documents the information of which is output to the file server security explorer tool.

For this purpose, in the present invention, the management server 10 further includes a document classification module 11.

The document classification module 11 checks a relevant user's rights by searching the authorized user information DB 13 in the user authentication process, which is conducted in the user verification module 12, extracts accessible documents corresponding to the rights by searching the first, second and third document DBs 22, 23 and 24 using the search engine 21 of the file server 20, and sends information about the resulting documents to the client terminal 30 in conjunction with the operation of the security explorer tool driving module 31.

Since the authorization limits for viewing of documents may be different for respective users in the same department having a team including a plurality of users through the above-described classification of documents for respective users, there is an advantage in that the security of the documents in the file server 20 can be defined in detail.

Meanwhile, in order to check a user's authorization limits for viewing of documents and allow the user to access and view the documents within the authorization limits, the storage device of the file server 20 may be implemented in various embodiments. The respective embodiments will be disclosed below.

A plurality of first, second and third document DBs 22, 23 and 24 may be established in the file server 20, and the first, second and third document DBs 22, 23 and 24 may store documents that have been classified according to security level. That is, the document classification module 11 checks the authorization limits of a relevant user, and opens only one or more relevant document DBs. As a result, only the documents of the opened document DBs are opened to the user's client terminal 30 through the security explorer tool.

Furthermore, an information file, in which data about a security level is recorded, is created for each document, so that only documents corresponding to a relevant user may be searched for and be opened to the user's client terminal 30.

However, the method in which the control system according to the present invention opens documents only to the client terminal 30, 30′ or 30″ is merely an embodiment, but a method of opening all documents regardless of users and client terminals 30, 30′ and 30″ and allowing viewing to be performed within the authorization limits of the users and the client terminals 30, 30′ and 30″ may also be employed.

A detailed description of the immediately preceding embodiment will be made again with reference to a description of an approval agent module 15.

When only a single document DB is provided in the file server 20, and then it is impossible to classify and store documents for respective document DBs, the concept of a virtual disc is applied to the document DB, so that the document DB is divided into a plurality of document DBs. The document DBs resulting from such division are controlled such that authorization to access the document DBs is controlled differently for respective document DBs, thus realizing the same effect as that obtained when a plurality of first to third document DBs 22, 23 and 24 is provided, as described above.

However, the application of the concept of a virtual disc to the file server 20 is only an embodiment for implementing the file server 20, which is one component of the system according to the present invention, and the following embodiments, other than the application of the concept of a virtual disc, can be realized.

The file server 20 has the same structure as a typical file server, verifies a client terminal 30, 30′ or 30″ or a user through the user verification module 12, and allows only an authorized client terminal 30, 30′ or 30″ or an authorized user to access the file server 20. Therefore, an indication of a drive, showing the file server 20, is output to a given client terminal 30, 30′ or 30″ regardless of whether authorization has been granted, thus allowing the user to be aware of the presence of the file server 20 through the indication of the drive. When an authorized user attempts to access the file server 20, the access is granted, whereas, when an unauthorized user attempts to access the file server 20, a window showing a message, such as “access is denied” is output, thereby notifying the current user that access to the security explorer tool is impossible.

However, it is also possible to prevent an unauthorized user from being aware of the presence of the file server 20 itself by differently setting an indication of a drive for the respective client terminals 30, 30′ and 30″ according to whether authorization has been granted.

An embodiment in which a virtual disk is applied to the file server 20 according to the present invention will be described below.

Since the concept of a virtual disk is described in detail in “Access Control System and Method for Respective Application Programs using Virtual Disk (Korean Patent No. 10-0596135)” which was filed and the patent rights of which is possessed by the present applicant, a description of a virtual disk will be omitted. A description of the application of the virtual disk to the present invention will be described below.

A virtual disk, defined in “Access Control System and Method for Respective Application Programs using Virtual Disk (hereinafter referred to as ‘prior art invention’)”, is installed in a hard disk (although a hard disk is considered to be a simple data storage recording device in a general-purpose local PC, the hard disk may be called a DB and may be considered to be a DB in the case of a server connected to clients via a network or the Internet. Therefore, in the present invention, a hard disk, which is a space to which a virtual disk is applied, includes not only the hard disk of a general-purpose PC but also the DB of a server. Here, the DB is a file server), and is configured to classify applications that attempt to access the virtual disk into an authorized application module and an unauthorized application module and controls the access of the application modules. In the present invention, a virtual disk is installed in the file server, and whether the client terminals and users that attempt to access the file server have been authorized is checked, thereby controlling access to the file server.

That is, when the security explorer tool driving module 31 verifies a user and then drives the security explorer tool, only one or more virtual disk drives corresponding to the authorization limits of the verified user are output within the security explorer tool so as for the user to access them. Of course, in the case in which the user's authorization limits for access does not include a specific virtual disk drive, the security explorer tool does not output the virtual disk drive.

In brief, if, in the prior art invention, for example, a security file stored in a virtual disk should be retrieved so as for an authorized application to perform work, the authorized application can detect the security file by executing a retrieval function (the case of a Windows system is an example). Since this is a retrieval function executed by the authorized application, the security file is considered to be a file stored in a separate drive (the virtual disk is recognized as a separate drive by the Operating System (OS)) and is easily found and retrieved. However, in the case of an unauthorized application, the security file cannot be retrieved even if the retrieval function is executed because the corresponding drive does not exist as a target for retrieval. That is, the OS recognizes the virtual disk not as a separate drive but as a single file.

As described above, the system for controlling the entry and exit of document to and from a file server according to the present invention includes a plurality of virtual disks, and classifies them into first, second, third document DBs 22, 23, and 24, and verifies the authorization limits of a user who attempted access, so that only the document DBs authorized for the corresponding user are recognized as independent drives in the security explorer tool.

Meanwhile, after a user accesses a document DB, the user can store one or more documents stored in the document DB using respective ‘other names’ while viewing the documents. That is, the documents can be stored in another document DB or in a user's client terminal 30, 30′, or 30″, which is a local area, instead of the file server 20.

This also can be restricted using a virtual disk function. That is, the user, who retrieves a document from the first document DB 22 and is performing work on it, can retrieve documents stored in the second and third document DBs 23 and 24 (in the case in which the corresponding user has been authorized to access documents stored in the second and third document DBs) and view them, but cannot edit or store them. Of course, the user can retrieve the stored documents to his or her client terminal, which is a local area and view them, but cannot edit or store them.

Therefore, after the user closes the document of the first document DB 22 and then disconnects the first document DB 22, the user can retrieve other documents from the second and third document DBs 23 and 24, and then can view, edit, or store them.

S16: Document Viewing Step

A user accesses the file server through the file server security explorer tool, and views one or more desired documents.

If access to the file server 20 has been authorized, the user is authorized to view one or more documents stored in the document DB. Here, the view is classified as view which allows only ‘opening a document’, as view which allows ‘opening a document’ and ‘editing a document’, and as view which allows ‘opening a document’, ‘editing a document’, and ‘transferring a document’. That is, for the same document, the usage methods thereof can be divided according to the authorization limits of respective users.

For this purpose, the authorization limits of respective users for documents are also recorded in the authorized user information DB 13. When a document is provided to a user, an information file is associated with the document based on the record of the corresponding user, so that the user can view and process the document according to on his or her authorization limits.

Thereafter, when a plurality of users simultaneously attempts to access a document, stored in the file server, through different client terminals 30, 30′, and 30″, the system for controlling the entry and exit of documents to and from a file server according to the present invention performs processes of verifying whether the user has been authorized to access the document and encrypting/encrypting the corresponding document at the level of a document DB, which stores the document, rather than at the level of an individual document. Therefore, even if the plurality of users attempts to access a single document, the possibilities of collision for document processing between users, damage to the document attributable to the collision, and incorrect operation attributable to the performance of encryption/decryption are minimized, thereby realizing a more stable system.

That is, the file server according to the present invention stores documents in a general file form, on which encryption is not performed, but performs encryption only on a process of accessing the file server. Therefore, when an authorized client terminal or a user attempts access, and thus connection between the file server and the authorized client is realized, the authorized client terminal or the user can access and view necessary documents as usual, as when viewing documents, without performing a separate procedure or process.

S17; Document Exit Determination Step

The user may intend and perform the transfer of the relevant document after the document viewing step S16, or even before the viewing of the document. The transfer of the document may be performed in various manners. The control system according to the present invention controls the entry and exit and documents through the external devices 51 and 52, which are connected to and separated from the client terminals 30, 30′ and 30.″

S30; Exit State Determination Step

When the user intends to transfer the document from the file server 20 at the document exit determination step S17, the user verification module 12 receives a signal from the client terminal 30, 30′ or 30,″ and searches the authorized user information DB 13 for the rights of the user.

Meanwhile, the exit of a document may be handled in various ways. That is, there may be a way of encrypting a relevant document at the time of exit and allowing the document to be viewed only in the client terminal 30, 30′ or 30″ and a way of converting the relevant document into plain text and allowing the document to be viewed in any client terminal as long as an application capable of reading the document has been installed in the client terminal.

In general, since the former way is advantageous with respect to security, the latter way must be used only for trustworthy users.

As a result, when the user intends to transfer the document to the outside and inputs information about the transfer of the document to the client terminal 30, 30′ or 30″, whether to perform the exit of the document in an encrypted way or a plain-text way must be determined.

S31 and S33; Rights Checking Steps

The conversion of documents into plain text requires that users be more reliable than in the case of the encryption of documents. As a result, when the user selects the exit of the document in a plain-text way, the user must have relevant qualifications therefor, that is, relevant rights.

However, since the user has already been authenticated in order to run the security explorer tool and obtain information about documents or the document DB output through the security explorer tool, the present rights checking steps S31 and S33 may be steps that do not need to be conducted.

However, in the control system according to the present invention, the exit of documents through the external devices 51 and 52 does not necessarily require a system such as the above-described security explorer tool. That is, the reason for this is that the control system according to the present invention may be applied even to a system in which the work of accessing the file server 20, in which the entry and exit of documents are controlled, using the client terminals 30, 30′ and 30″, searching for necessary documents and transferring found documents from the file server is performed.

Accordingly, in the control system according to the present invention, the rights checking steps S31 and S33 may be performed after the document exit determination step S17, or may be performed at the authorization checking step S12.

S32 and S34; Storage Device Verification Step

When the user is determined to have rights at the rights checking steps S31 and S33, whether the relevant user has rights to transfer the document from the file server 20 is determined. If the relevant user has rights to transfer the document from the file server 20, whether the relevant document can be transferred from the file server 20 in an encrypted manner or a plain-text manner is determined. If the user is determined to have rights to transfer the document from the file server 20, the external device 51 or 52, which is a means for transferring the relevant document from the file server, is verified.

For this purpose, each of the client terminals 30, 30′ and 30″ includes the external device recognition module 35. The external device recognition module 35 reads a code for identifying the external device 51 or 52, identifies the type of external device 51 or 52 currently connected to the client terminal 30, 30′ or 30″, and determines whether the external device 51 or 52 has been authorized. Here, the code may be the manufacturer and device names of the external device 51 or 52, or may be an authentication means, such as an electronic signature or a certificate. Here, the authentication means is installed in the external device 51 or 52 so as to cause the relevant external device 51 or 52 to operate in conjunction with the control system according to the present invention. When the external device 51 or 52 is connected to the client terminal 30, 30′ or 30,″ the external device recognition module 35 recognizes the authentication means and sends data about the authentication means to the external device verification module 18 of the management server 10. The external device verification module 18 determines whether the relevant external device 51 or 52 is an authorized external device 51 or 52 by searching the external device DB 17, in which data about the code or authentication means is stored.

If, as a result of the determination by the external device verification module 18, the relevant external device 51 or 52 is determined to be an authorized external device 51 or 52, the subsequent step is performed.

S35; Exiting Document Encryption Step

If the exiting document is determined to be encrypted, encryption is performed before the exit of the relevant document. As a result, even when the user normally inputs the relevant document to the external device 51 or 52, the document is encrypted, so that the document cannot be executed using a typical application, and thus the document can be executed only in a terminal capable of decrypting the encryption.

Means for encryption and decryption are various. Since such means are well known in the related field, a description thereof will be omitted here.

In contrast, if the document is determined to be stored in a plain-text way, the document can be transferred from the file server in its original format without encryption, so that a separate encryption step does not need to be conducted.

S36; Exiting Document Storage Step

When a document is transferred from the file server, the original or copy of the document to be transferred from the file server is temporarily or permanently stored in a file logger 40. The reason for this is to protect the original of the document stored in the file server 20 and then allow the selected document to be transferred from the file server 20.

S37; Document Transfer Approval Step

The user who desires to transfer the document from the file server may obtain approval for the exit of the relevant document from a superior if necessary. This approval step will be described in detail below.

S39; Document Transfer Step

If the superior's approval has been normally obtained, the document stored in the file logger 40 is input to the external device 51 or 52 through transmission. Of course, if the exit of the document is not approved at the document exit approval step S37, further processing is not carried out, and thus the user cannot transfer the relevant document from the file server.

Next, the case in which work other than the transfer of the document is determined to be performed at the document exit determination step S17 will be described.

S18; Another Document Selection Determination Step

After viewing the document stored in the file server 20 through the above process, the user can attempt to view another document. This is simply performed by clicking the icon or name of another document output through the security explorer tool.

S20; Document Selection Step

The user accesses the file server 20 through the client terminal 30, 30′ or 30″ and searches the file server 20 for a desired document. In the above description, a means used to access the file server 20 and search for a document is implemented using a security explorer tool, but an approval operation, performed using the approval agent module 15, which will be described below, is not necessarily performed, on the assumption that the security explorer tool is used.

However, in the following description, embodiments of the control system using the security explorer tool are successively described, and the definite scope of the present invention will be defined by the accompanying [claims].

Next, the user checks documents, stored in the file server 20, using the security explorer tool and determines whether to view a relevant document. However, in the above-described embodiments, the security explorer tool opens only documents that the user can view, thus preventing the user from accessing unauthorized documents at the outset. However, this is only an embodiment of the present invention, and it is also possible to open the titles or icons of unauthorized documents to the user.

Therefore, embodiments of the control system according to the present invention will be described on the assumption that the following steps are performed on the condition that even unauthorized documents are opened to a user.

S22; Document Viewing Range Checking Step

The user checks his or her viewing range for a relevant document. That is, whether the user can open, edit, or transfer a selected document is determined.

This step is described in detail below. The user's rights to view a specific document are restricted and discriminately assigned according to his or her position, rank or requirement to conduct work. Therefore, the user can check his or her viewing range for the specific document by clicking the icon or name of the document that is opened through the client terminal 30, 30′ or 30″.

The checking of a document viewing range can be performed using various methods. Several embodiments thereof will be described in detail below.

(1) All documents stored in the file server 20 are opened regardless of the classification of document DBs, and thus the user can check his or her viewing range for each document.

(2) Documents stored in the file server 20 are classified into document DBs, and thus the user can check his or her viewing range for the documents stored in each document DB for which the user has access rights.

(3) Documents stored in the file server 20 are classified into respective document DBs, and thus the user can check a document DB for which the user has access rights. In this case, the user can access all documents present in the document DB. However, it is apparent that, even in the case of the documents present in the same document DB, the rights of respective users to view the documents can be discriminately assigned.

S24; Authorization Limits Extension Approval Step

The user may need to view or access a document or a document DB. However, in order for the user to view a document for which he or she does not have rights, in the file server for which viewing and access are uniformly controlled, overall processing must be performed on the system, and a lot of work must be performed offline.

However, in the case where work must be promptly conducted, there is a heavy burden in that a user in charge of work spends a lot of time viewing a document for which he or she does not have viewing rights.

Therefore, when there is a need to view or access an unauthorized document or document DB, the user's viewing rights can remain updated for a short period or a long period after obtaining a superior's approval.

The control system of the present invention may include approval modules for processing approval between users and superiors, and an approval agent module 15, and may further include an update module 16 for updating the authorized user information DB 13.

The approval modules are installed in the client terminals 30, 30′ and 30″, and are called first, second and third approval modules 34, 34′, and 34″. Each of the first, second and third approval modules 34, 34′ and 34″ is the control device of an application for guiding a user through requesting approval and a superior through giving approval using a well-known method such as an electronic signature. The first, second or third approval module 34, 34′ or 34″ is configured to record the information of the user of each client terminal 30, 30′ or 30″, and to verify the user by checking the recorded user information at the time of running the first, second or third approval module 34, 34′ or 34″, or verify the user by checking the ID/password input by the user to run a security explorer tool.

Meanwhile, the communication and control of the first, second and third approval modules 34, 34′ and 34″ are performed by the approval agent module 15 of the management server 10.

The approval method according to the present invention is sequentially described (including the approval step S26).

(1) The user can request that a superior extend the user's rights for a document, for which the user does not have viewing rights, among the documents checked at the document viewing range checking step S22.

For this purpose, the first approval module 34, provided in the client terminal 30 of the user, is run.

(2) Although the running of the first approval module 34 can be performed in various forms in the client terminal 30, an embodiment of the present invention uses a method of displaying a pop-up window.

That is, if it is determined that the user does not have viewing rights for a relevant document or that a required document is located in a document DB that is inaccessible to the user when the user accesses the file server 20 and checks the document, the user runs the first approval module 32 to view or access the document or the document DB. The running of the first approval module 34 is performed by outputting a pop-up window, which enables the extension of the authorization limits and viewing rights of the user to be set and commanded, to the client terminal 30.

(3) The user inputs information about a document or a document DB, desired to be viewed or accessed, according to the display format of the pop-up window. In the case of a document, a GUI configuration, through which the range of viewing can be input, may be added to the pop-up window. Here, the viewing range is a range indicating whether ‘open’, ‘edit’ and ‘transfer’ is possible. When the user has only the right to ‘open’ the document, the user can request the right to ‘edit’ or ‘transfer’ the document to conduct work through the GUI configuration.

(4) The approval agent module 15 receives data about the extension of the user's authorization limits and viewing rights from the first approval module 34, checks the user's superior, and transmits the received data to the superior's client terminal 30′.

Here, the superior may be an administrator for a document desired to be viewed by the user, or may be the user's superior in rank.

(5) The data received from the approval agent module 15 is received by the second approval module 34′, which is installed in the superior's client terminal 30′. The second approval module 34′ displays a pop-up window on the client terminal 30′ to allow the superior to check the details of the data.

(6) The superior verifies the identity of the user, requesting approval, and the request details, that is, details about the change of the user's rights to view or access a document or a document DB, in the pop-up window displayed on the client terminal 30′, determines whether to change the user's viewing rights or access, and makes approval or denial on the basis of the determination. The approval or denial can be made using electronic signature, or can be simply made by selecting “Yes” or “No” in the case of a reliable client terminal 30′.

(7) Meanwhile, when the superior is not a person having the highest authority of decision, the superior can request approval from his or her superior (hereinafter referred to as a ‘highest superior’) with reference to the request details of the user. Therefore, in order to obtain approval from the highest superior, the superior confirms his or her approval, and then transmits resultant data to the approval agent module 15. The approval agent module 15 transmits the resultant data to the highest superior's client terminal 30.″

(8) The third approval module 34″ installed in the client terminal 30″ receives the resulting data, and displays a pop-up window using the same method as described above, thereby enabling the highest superior to check the details to be approved or denied.

(9) The highest superior checks the details to be approved or denied, approves or denies the details using the above-described method, and transmits the final resultant data to the approval agent module 15.

The above-described approval procedure is applied to the transfer of documents of the control system according to the present invention.

In greater detail, the user desires to transfer a document from the system, including the management server 10, the file server 20 and the client terminals 30, 30′ or 30,″ using the external device 51 or 52, and whether to allow the transfer of the document may be determined through a superior's approval.

Accordingly, the user requests approval for the transfer of the document (or the extension of authorization limits) from the superior according to the above-described approval procedure. At this time, the original or copy of the target document is stored in the file logger 40. If the transfer of the document is determined, the document stored in the file logger 40 is sent to the external device 51 or 52 of the target client terminal 30, 30′ or 30″.

That is, when the user performs the document transfer approval step S37 so as to transfer the document from the file server, the target document is copied and then remains in the file logger 40, and the approval relay module 15 communicates not with the file server 20 but with the file logger 40 so as to find the target document while communicating with the first, second or third approval module 34, 34′ or 34″ of the client terminal 30, 30′ or 30. As a result, the user can transfer only the relevant document, which is a target for the approval, from the file server, thereby overcoming the problem with the prior art system, in which, after the approval for the transfer of a specific document, some other document can be transferred from the file server without authorization.

S28; Authorization Limit Change Step

When the approval agent module 15 receives the final resulting data from the highest superior, the information of the user stored in the authorized user information DB 13 is changed/updated for a short period or a predetermined period by the update module 16 on the basis of the results of the approval.

That is, as the recording of the user's authorization limits and viewing rights is changed by the update module 16, the document classification module 11 allows the user to view or access a document or a document DB on the basis of the updated authorized user information DB 13.

FIG. 6 is a block diagram showing a control system according to another embodiment of the present invention. The following description will be given with reference to this drawing.

The control system according to the present invention further includes a file logger 40.

The file logger 40 stores the history of viewing of a document when a user accesses the file server 20 and views the document. That is, the file logger 40 records a user, a client terminal 30, 30′ or 30″ used by the user, the time at which access to the file server was made, a viewed document, and a document DB in which the document is stored.

Further, when a document stored in a document DB is viewed by a user and then the information of the document is newly updated through an editing process or the like, an original document, which is not updated, is stored in the file logger 40 so as to preserve the original of the corresponding document.

The record in the file logger 40 is used as information which is used for post inspection or is used to detect a leakage path when a document is leaked.

Meanwhile, a system for controlling the entry and exit of documents to and from a file server according to another embodiment of the present invention includes an application authentication module 33 for verifying whether an application that opens one or more documents stored in the file server 20 has been authorized, and an application verification module 14 for verifying whether an application, installed in a currently accessed client terminal 30, 30′, or 30″, has been authorized while communicating with the application authentication module 33.

For example, even if a client terminal 30, 30′ or 30″, in which a Computer-Aided Design (CAD) program (application) capable of executing a “*.dwg” format file (document) is installed, can normally access the corresponding file server 20 and view the “*.dwg” format file, the corresponding “*.dwg” format file cannot be opened if the CAD program has not been authorized.

For this purpose, an authentication file is installed in an application authorized to access the file server 20, and an authentication verification file corresponding to the authentication file is installed in the application verification module 14. When an arbitrary application is run, whether the application has been authorized to access the file server 20 is verified. If, as the result of the verification of the application verification module 14, it is determined that the corresponding application has been authorized to access the file server 20, the security explorer tool driving module 31 is run normally and thus allows a user to search the file server 20 for documents.

Even when encryption/decryption is performed on a document stored in the file server 20 at the level of a document rather than at the level of a document DB, the operation of encrypting/decrypting the document is performed without requiring an additional operation by the users in the case in which an authorized client terminal 30, an authorized user, and an authorized application attempt to open the corresponding document. Therefore, a problem of collision between operations, attributable to the encryption/decryption of respective users, can be solved even if two or more users simultaneously access and attempt to open a corresponding document.

1. A control system comprising a management server, a plurality of client terminals configured to comprise first and second client terminals and communicate with the management server, and a file server configured to store documents shared by the first and second client terminals, wherein:
each of the first and second client terminals comprises an external device recognition module that reads codes of external devices that are communicably connected to or separated from the first or second client terminal: and
the management server comprises an external device DB that stores the codes of the external devices, and an external device verification module that, when a code of an external device, connected to the first or second client terminal, is received from the external device recognition module, searches the external device DB for information about the code, and performs control so that a document stored in the file server is stored in the external device connected to the first or second client terminal and is then transferred from the file server if the information about the code is found to exist as a result of the search.

2. The control system as set forth in claim 1, wherein:
the first client terminal comprises a first approval module that outputs a first window, to which a first user can input a request for viewing (including exit) of a document, and sends data, input to the first window by the first user, to the management server;
the second client terminal comprises a second approval module that outputs a second window for displaying the data from the management server and sends data about whether the first user has been approved to view the document, input to the second window by the second user, to the management server; and
the management server comprises an approval relay module that relays the data and the approval data between the first approval module and the second approval module and opens the document to the first client terminal when the approval data includes information about approval of viewing of the document.

3. The control system as set forth in claim 2, wherein the first approval module comprises a file logger that copies the document when the data input to the first window is sent to the management server and stores the copied document so that the approval relay module can open (including “transfer from the file server”) the document to the first client terminal.

4. The control system as set forth in claim 1, wherein:
the first and second client terminals comprise respective file server access modules that verify the first and second users, attempting to access the file server, and respective security explorer tool driving modules that output the document stored in the file server if the file server access module determines that the first and second users have rights to access the file server; and
the management server comprises an authorized user information DB that stores the first and second users' authorization information about access to the file server and authorization limits of access to the file server, a user verification module that checks first and second user information from the file server access module, and searches for authorization information stored in the authorized user information DB, and a document classification module that restricts documents, opened to the first and second client terminals by the security explorer tool driving module, with respect to the first and second users by searching the file server for documents within the authorization limits of the first and second users based on the authorization information from the user verification module and sending the information about the found documents to the security explorer tool driving module.

5. The control system as set forth in claim 4, wherein:
the first and second client terminals further comprise respective application authentication modules that read authentication files that are installed in executable applications; and
the management server further comprises an application verification module that controls running of the security explorer tool driving module by checking the authentication files from the application authentication modules.

6. The control system as set forth in claim 2, wherein the management server further comprises an update module that, when the approval relay module allows the first user to view a specific document, updates information of the authorized user information DB so that the first user can open or view the specific document using the security explorer tool upon accessing the file server.

7. The control system as set forth in claim 2, wherein:
the first and second client terminals comprise respective file server access modules that verify the first and second users, attempting to access the file server, and respective security explorer tool driving modules that output the document stored in the file server if the file server access module determines that the first and second users have rights to access the file server; and
the management server comprises an authorized user information DB that stores the first and second users' authorization information about access to the file server and authorization limits of access to the file server, a user verification module that checks first and second user information from the file server access module, and searches for authorization information stored in the authorized user information DB, and a document classification module that restricts documents, opened to the first and second client terminals by the security explorer tool driving module, with respect to the first and second users by searching the file server for documents within the authorization limits of the first and second users based on the authorization information from the user verification module and sending the information about the found documents to the security explorer tool driving module.

8. The control system as set forth in claim 3, wherein:
the first and second client terminals comprise respective file server access modules that verify the first and second users, attempting to access the file server, and respective security explorer tool driving modules that output the document stored in the file server if the file server access module determines that the first and second users have rights to access the file server; and
the management server comprises an authorized user information DB that stores the first and second users' authorization information about access to the file server and authorization limits of access to the file server, a user verification module that checks first and second user information from the file server access module, and searches for authorization information stored in the authorized user information DB, and a document classification module that restricts documents, opened to the first and second client terminals by the security explorer tool driving module, with respect to the first and second users by searching the file server for documents within the authorization limits of the first and second users based on the authorization information from the user verification module and sending the information about the found documents to the security explorer tool driving module.

9. The control system as set forth in claim 3, wherein the management server further comprises an update module that, when the approval relay module allows the first user to view a specific document, updates information of the authorized user information DB so that the first user can open or view the specific document using the security explorer tool upon accessing the file server.

10. The control system as set forth in claim 5, wherein the management server further comprises an update module that, when the approval relay module allows the first user to view a specific document, updates information of the authorized user information DB so that the first user can open or view the specific document using the security explorer tool upon accessing the file server.
